(19) United States
(12) Patent Application Publication
(10) Pub. No.: US 2025/0375736 A1
(43) Pub. Date: Dec. 11, 2025

(54) SCR CATALYSTS WITH BLENDED OXIDES AND H-ZEOLITES

(71) Applicant: BASF CORPORATION, Florham Park, NJ (US)

(72) Inventors: Yuejin LI, Iselin, NJ (US); Xinyi WEI, Iselin, NJ (US); Andreas SUNDERMANN, Heidelberg (DE)

(21) Appl. No.: 18/716,776

(22) PCT Filed: Dec. 1, 2022
(86) PCT No.: PCT/US2022/080717

§ 371 Date: Jun. 5, 2024

(30) Foreign Application Priority Data
Dec. 6, 2021 (EP) 21212603.1

(51) Int. Cl. B01D 53/94; B01J 23/10; B01J 23/30; B01J 23/34; B01J 29/16; B01J 29/26; B01J 29/48; B01J 29/78; B01J 37/02; B01J 37/08; F01N 3/035; F01N 3/10; F01N 3/20; F01N 3/28

(52) U.S. Cl. CPC B01D 53/9418; B01J 23/10; B01J 23/30; B01J 23/34; B01J 29/16; B01J 29/26; B01J 29/48; B01J 29/7815; B01J 29/783; B01J 37/0201; B01J 37/088; F01N 3/035; F01N 3/106; F01N 3/2066; F01N 3/2803; B01D 2251/2062; B01D 2251/2067; B01D 2255/2073; B01D 2255/502; B01D 2255/504; B01D 2257/404; B01D 2258/012; F01N 2370/04; F01N 2610/02

(57) ABSTRACT

Disclosed herein are catalyst compositions for treating an exhaust gas comprising nitrogen oxides (NOₓ) using ammonia or urea that comprise an oxide or mixed-oxide support optionally impregnated with a metal oxide dopant to form an oxide catalyst that is blended with an H-zeolite, or zeolite capable of being converted into an H-zeolite. The disclosure also relates to processes for making such catalyst compositions, and processes and methods for reducing NOₓ formation using the catalyst compositions and catalytic articles with the catalyst composition deposited thereon.

This application claims the benefit of European Patent Application No. 21212603.1, filed on 6 Dec. 2021, the contents of which is incorporated by reference herein in its entirety.

The present disclosure is directed to catalyst compositions comprising an H-zeolite, or a zeolite capable of being converted to an H-zeolite, and oxide based catalysts, as well as to processes for the selective catalytic reduction (SCR) of nitrogen oxides (NOₓ) using NH₃ or urea, for example for diesel applications. The disclosure also relates to effective approaches for improving the catalytic performance of oxide-based NH₃-SCR catalysts.

Nitrogen oxides (NOₓ) such as nitric oxide (NO) and nitrogen dioxide (NO₂) are some of the principal contributors to smog and other undesirable environmental effects when they are discharged to the atmosphere. Because of the harmful effects of these gases, most governmental authorities restrict industrial emissions in an attempt to limit the oxides in the atmosphere. For instance, regulations worldwide mandate ever lower emissions from vehicles.

The use of zeolite-based catalysts with a reductant such as ammonia or urea to treat exhaust gas and reduce NOₓ gases to elemental nitrogen and steam is a well-established procedure, commonly referred to as selective catalytic reduction (SCR).

Cu-zeolites are generally the most active type of catalyst for NOₓ reduction for diesel vehicles, but its activity is not high enough below about 200° C. At low temperatures, a Cu-zeolite catalyst also needs to be saturated with NH₃ before it can be effective for NOₓ reduction. This slows down the response to urea injection. Additionally, in terms of cost, Cu-CHA is one of the most expensive catalysts to produce.

V₂O₅/TiO₂ based catalysts require less NH₃ filling, but are much less active at low temperatures. Moreover, the use and possible escape of V₂O₅ to the ambient is an environmental concern.

Thus, efficient removal of NOₓ at low temperatures (less than about 200° C.) is an unmet need and a great challenge for the mobile emission industry.

The present disclosure offers a cost-effective approach to increasing NOₓ conversion and decreasing N₂O formation for oxide-based SCR catalysts. Applicants surprisingly found that by forming catalytic compositions by physically blending a small amount of an H-form of zeolite, or a zeolite capable of being converted to an H-zeolite, with an oxide-based catalyst leads to a significant increase in NOₓ conversion and a decrease in N₂O formation relative to the oxide-based catalyst. This effect appears to be synergistic, i.e., the activity of the blended catalyst is higher than the sum of the individual components.

This effect has been demonstrated to be effective for several types of zeolites and many oxide and mixed-oxide materials, and works for both powder and coated monolith catalysts.

The catalytic system of the present disclosure is also suitable for heavy-duty applications positioned at the close-couple position, and addresses the challenge to effectively control NOₓ emissions from diesel engines at low temperatures using cost-effective solutions.

The present disclosure provides a catalyst composition for treating an exhaust gas comprising NOₓ using ammonia or urea. The catalyst composition comprises an oxide or mixed-oxide support that is impregnated with a metal oxide dopant to form an oxide catalyst. The oxide catalyst comprises an H-zeolite, or a zeolite capable of being converted to an H-zeolite. The H-zeolite, or a zeolite capable of being converted to an H-zeolite, and the oxide catalyst are blended together.

The oxide or mixed-oxide support of the catalyst composition is chosen from MnO₂/ZrO₂, WO₃/TiO₂, WO₃/Al₂O₃, SiO₂/Al₂O₃, Ce/Zr/La, Ce/Zr/La/Y, CeO₂, CeO₂/Al₂O₃, and combinations thereof. The metal oxide dopant of the catalyst composition is chosen from MnO₂, CeO₂, Nb₂O₅, CuO, and combinations thereof. The H-zeolite catalyst, or zeolite capable of being converted to an H-zeolite, of the catalyst composition is chosen from structures comprising BEA, FER, MOR, MFI, FAU, CHA, and combinations thereof.

The H-zeolite, or a zeolite capable of being converted to an H-zeolite, comprises from about 5 wt % to about 50 wt % of the oxide catalyst. The metal dopant comprises from about 1 wt % to about 20 wt % of the oxide catalyst. The oxide or mixed-oxide support is about 20% CeO₂/Al₂O₃. The metal oxide dopant is about 5% wt % MnO₂. The H-zeolite structure, or zeolite capable of being converted to an H-zeolite, is about 20 wt % BEA. The oxide or mixed-oxide support is about 18% MnO₂/ZrO₂. The H-zeolite structure, or zeolite structure capable of being converted to an H-zeolite structure, is about 20 wt % BEA.

The catalyst composition of the present disclosure is in a form chosen from a powder and a coated monolith.

The present disclosure also provides for a process of making a catalyst composition. The process comprises depositing one or more oxide dopants onto an oxide or mixed-oxide support using an incipient wetness technique or by precipitation to form an oxide catalyst. The oxide catalyst is physically blended with an H-zeolite, or with a zeolite capable of being converted to an H-zeolite, in a slurry state to form a blend. The blend is calcined at a temperature of at least about 450° C. for about 1 hour to obtain the catalyst composition.

The present disclosure also provides for a process for reducing NOₓ formation in an exhaust gas. The process comprises contacting the exhaust gas stream, in the presence of a reducing agent, with a catalyst composition of the present disclosure. The temperature of the process is less than or about 250° C. The temperature of the process is about 200° C. Also provided is a catalytic article comprising a substrate having a plurality of channels for gas flow and the catalyst composition of the present disclosure disposed thereon.

The present disclosure further provides for a method for treating an exhaust gas comprising NOₓ. The method comprises contacting the exhaust gas with the catalytic article of the present disclosure for a time and at a temperature ranging from about 200° C. to about 250° C. or higher. The method is used in a heavy-duty application positioned at a close-couple position. The level of NOₓ conversion in the exhaust gas is at about 250° C. and is at least about 18% higher than the catalyst composition without the H-zeolite, or without a zeolite capable of being converted to an H-zeolite, blended therein. The formation of N₂O at about 250° C. is at least about 5 times lower than the catalyst composition without the H-zeolite, or without a zeolite capable of being converted to an H-zeolite, blended therein.

Also provided herein is an emission treatment system for treating an exhaust gas stream. The emission treatment system comprises an engine producing an exhaust gas stream and the catalytic article of the present disclosure positioned downstream from the engine and in fluid communication with the exhaust gas stream. The emission treatment system can further comprise one or more of a diesel oxidation catalyst (DOC), a catalyzed soot filter (CSF), a soot filter, an ammonia oxidation (AMOₓ) catalyst, a lean NOₓ trap (LNT), and a nitrogenous reductant injector.

### BRIEF DESCRIPTION OF THE FIGURES

FIG. 1 is a graph showing a comparison of catalyst performance between 2 g/in³ 8% Nb₂O₅/1% CuO/CeO₂ (Monolith Sample 1) and 1.6 g/in³ 8% Nb₂O₅/1% CuO/CeO₂+0.4 g/in³ H-CHA (Monolith Sample 2) coated monolith catalysts on NOₓ conversion.

FIG. 2 is a graph showing a comparison of catalyst performance between 2 g/in³ 8% Nb₂O₅/1% CuO/CeO₂ (Monolith Sample 1) and 1.6 g/in³ 8% Nb₂O₅/1% CuO/CeO₂+0.4 g/in³ H-CHA (Monolith Sample 2) coated monolith catalysts on N₂O conversion.

FIG. 3 is a graph showing a comparison of fresh catalyst performance between 2 g/in³ 6.6 wt % MnO₂/3.4 wt % TiO₂/90 wt % CeO₂/Al₂O₃ (Monolith Sample 3) and 2 g/in³ 6.6 wt % MnO₂/3.4 wt % TiO₂/90 wt % CeO₂/Al₂O₃+0.4 g/in³ H-Beta (Monolith Sample 4).

FIG. 4 is a graph showing a comparison of aged catalyst performance between 2 g/in³ 6.6 wt % MnO₂/3.4 wt % TiO₂/90 wt % CeO₂/Al₂O₃ (Monolith Sample 3) and 2 g/in³ 6.6 wt % MnO₂/3.4 wt % TiO₂/90 wt % CeO₂/Al₂O₃+0.4 g/in³ H-Beta (Monolith Sample 4).

As used herein, “a” or “an” entity refers to one or more of that entity, e.g., “a vessel” refers to one or more vessels or at least one vessel unless stated otherwise. As such, the terms “a” (or “an”), “one or more,” and “at least one” are used interchangeably herein.

As used herein, the term “about” means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%.

The following description provides the various embodiments of the different aspects of the disclosed compositions, and methods and processes for a catalytic composition for treating an exhaust gas comprising NOₓ using ammonia or urea.

In some embodiments, the catalyst composition comprises an oxide or mixed-oxide support impregnated with a metal oxide dopant to form an oxide catalyst. In some embodiments, the oxide catalyst is mixed with an H-zeolite. In some embodiments, the oxide catalyst is mixed with a zeolite capable of being converted to an H-zeolite. In some embodiments, the oxide or mixed-oxide support is mixed with the H-zeolite. In some embodiments, the oxide catalyst or mixed-oxide support is mixed with a zeolite capable of being converted to an H-zeolite. In some embodiments, the H-zeolite and the oxide catalyst are blended. In some embodiments, the zeolite capable of being converted to an H-zeolite and the oxide catalyst are blended. In some embodiments, the H-zeolite and the oxide or mixed-oxide support are blended. In some embodiments, the zeolite capable of being converted to an H-zeolite and the oxide or mixed-oxide support are blended.

In some embodiments, the oxide or mixed-oxide support is chosen from MnO₂/ZrO₂, WO₃/TiO₂, WO₃/Al₂O₃, SiO₂/Al₂O₃, Ce/Zr/La, Ce/Zr/La/Y, CeO₂, CeO₂/Al₂O₃, and combinations thereof. In some embodiments, the oxide or mixed-oxide support is MnO₂/ZrO₂. In some embodiments, oxide or mixed-oxide support is WO₃/TiO₂. In some embodiments, the oxide or mixed-oxide support is WO₃/Al₂O₃. In some embodiments, the oxide or mixed-oxide support is SiO₂/Al₂O₃. In some embodiments, the oxide or mixed-oxide support is Ce/Zr/La. In some embodiments, the oxide or mixed-oxide support is Ce/Zr/La/Y. In some embodiments, the oxide or mixed-oxide support is CeO₂. In some embodiments, the oxide or mixed-oxide support is CeO₂/Al₂O₃.

In some embodiments, the oxide or mixed-oxide support is about 5% CeO₂/Al₂O₃. In some embodiments, the oxide or mixed-oxide support is about 10% CeO₂/Al₂O₃. In some embodiments, the oxide or mixed-oxide support is about 15% CeO₂/Al₂O₃. In some embodiments, the oxide or mixed-oxide support is about 5% MnO₂/ZrO₂. In some embodiments, oxide or mixed-oxide support is about 10% MnO₂/ZrO₂. In some embodiments, the oxide or mixed-oxide support is about 18% MnO₂/ZrO₂. In some embodiments, the oxide or mixed-oxide support is about 20% MnO₂/ZrO₂.

In some embodiments, the metal oxide dopant is chosen from MnO₂, CeO₂, Nb₂O₅, CuO, and combinations thereof. In some embodiments, the metal oxide dopant is MnO₂. In some embodiments, the metal oxide dopant is CeO₂. In some embodiments, the metal oxide dopant is Nb₂O₅. In some embodiments, the metal oxide dopant is CuO.

In some embodiments, the metal dopant comprises from about 1 wt % to about 20 wt % of the oxide catalyst. In some embodiments, the metal dopant comprises from about 2 wt % to about 10 wt % of the oxide catalyst. In some embodiments, the metal dopant comprises about 5 wt % of the oxide catalyst.

In some embodiments, the metal oxide dopant is about 5 wt % MnO₂ of the oxide catalyst. In some embodiments, the metal oxide dopant is about 5 wt % CeO₂ of the oxide catalyst. In some embodiments, the metal oxide dopant is about 5 wt % Nb₂O₅ of the oxide catalyst. In some embodiments, the metal oxide dopant is about 5 wt % CuO of the oxide catalyst. In some embodiments, the metal oxide dopant is about 10 wt % MnO₂ of the oxide catalyst. In some embodiments, the metal oxide dopant is about 10 wt % CeO₂ of the oxide catalyst. In some embodiments, the metal oxide dopant is about 10 wt % Nb₂O₅ of the oxide catalyst. In some embodiments, the metal oxide dopant is about 10 wt % CuO of the oxide catalyst.

In some embodiments, the zeolite is an H-zeolite. In some embodiment, the zeolite is chosen from zeolites that are capable of being converted to an H-zeolite. In some embodiments the zeolite is an NH₄-zeolite capable of being converted into an H-zeolite. In some embodiments, an NH₄-zeolite is converted to an H-zeolite by calcination. In some embodiments, the H-zeolite or zeolite capable of being converted into an H-zeolite has or is capable of having greater than about 95% exchangeable sites as H. In some embodiments, the H-zeolite or zeolite capable of being converted into an H-zeolite has or is capable of having greater than about 90% exchangeable sites as H. In some embodiments, the H-zeolite or zeolite capable of being converted into an H-zeolite has or is capable of having greater than about 85% exchangeable sites as H.

In some embodiments, the H-zeolite or zeolite capable of being converted into an H-zeolite is chosen from structures comprising BEA, FER, MOR, MFI, FAU, CHA, and combinations thereof. In some embodiments, the H-zeolite structure or zeolite structure capable of being converted into an H-zeolite structure comprises BEA. In some embodiments, the H-zeolite structure or zeolite structure capable of being converted into an H-zeolite structure comprises FER. In some embodiments, the H-zeolite structure or zeolite structure capable of being converted into an H-zeolite structure comprises MOR. In some embodiments, the H-zeolite structure or zeolite structure capable of being converted into an H-zeolite structure comprises MFI. In some embodiments, the H-zeolite structure or zeolite structure capable of being converted into an H-zeolite structure comprises FAU. In some embodiments, the H-zeolite structure or zeolite structure capable of being converted into an H-zeolite structure comprises CHA.

In some embodiments, the H-zeolite or zeolite capable of being converted into an H-zeolite comprises from about 5 wt % to about 50 wt % of the oxide catalyst. In some embodiments, the H-zeolite or zeolite capable of being converted into an H-zeolite comprises from about 10 wt % to about 40 wt % of the oxide catalyst. In some embodiments, the H-zeolite or zeolite capable of being converted into an H-zeolite comprises from about 20 wt % to about 30 wt % of the oxide catalyst. In some embodiments, the H-zeolite or zeolite capable of being converted into an H-zeolite comprises about 5 wt % of the oxide catalyst. In some embodiments, the H-zeolite or zeolite capable of being converted into an H-zeolite comprises about 10 wt % of the oxide catalyst. In some embodiments, the H-zeolite or zeolite capable of being converted into an H-zeolite comprises about 15 wt % of the oxide catalyst. In some embodiments, the H-zeolite or zeolite capable of being converted into an H-zeolite comprises about 20 wt % of the oxide catalyst. In some embodiments, the H-zeolite or zeolite capable of being converted into an H-zeolite comprises about 25 wt % of the oxide catalyst. In some embodiments, the H-zeolite or zeolite capable of being converted into an H-zeolite comprises about 30 wt % of the oxide catalyst. In some embodiments, the H-zeolite or zeolite capable of being converted into an H-zeolite comprises about 35 wt % of the oxide catalyst. In some embodiments, the H-zeolite or zeolite capable of being converted into an H-zeolite comprises about 40 wt % of the oxide catalyst. In some embodiments, the H-zeolite or zeolite capable of being converted into an H-zeolite comprises about 45 wt % of the oxide catalyst. In some embodiments, the H-zeolite or zeolite capable of being converted into an H-zeolite comprises about 50 wt % of the oxide catalyst.

In some embodiments, the H-zeolite structure or zeolite structure capable of being converted into an H-zeolite structure is about 10 wt % BEA of the oxide catalyst. In some embodiments, the H-zeolite structure or zeolite structure capable of being converted into an H-zeolite structure is about 10 wt % FER of the oxide catalyst. In some embodiments, the H-zeolite structure or zeolite structure capable of being converted into an H-zeolite structure is about 10 wt % MOR of the oxide catalyst. In some embodiments, the H-zeolite structure or zeolite structure capable of being converted into an H-zeolite structure is about 10 wt % MFI of the oxide catalyst. In some embodiments, the H-zeolite structure or zeolite structure capable of being converted into an H-zeolite structure is about 10 wt % FAU. In some embodiments, the H-zeolite structure or zeolite structure capable of being converted into an H-zeolite structure is about 10 wt % CHA of the oxide catalyst. In some embodiments, the H-zeolite structure or zeolite structure capable of being converted into an H-zeolite structure is about 20 wt % BEA of the oxide catalyst. In some embodiments, the H-zeolite structure or zeolite structure capable of being converted into an H-zeolite structure is about 20 wt % FER of the oxide catalyst. In some embodiments, the H-zeolite structure or zeolite structure capable of being converted into an H-zeolite structure is about 20 wt % MOR of the oxide catalyst. In some embodiments, the H-zeolite structure or zeolite structure capable of being converted into an H-zeolite structure is about 20 wt % MFI of the oxide catalyst. In some embodiments, the H-zeolite structure or zeolite structure capable of being converted into an H-zeolite structure is about 20 wt % FAU. In some embodiments, the H-zeolite structure or zeolite structure capable of being converted into an H-zeolite structure is about 20 wt % CHA of the oxide catalyst.

In some embodiments, the catalyst composition is a powder. In some embodiments, the catalyst composition is a coated monolith.

In some embodiments, there is provided a process of making a catalyst composition. In some embodiments, the process comprises impregnating one or more oxide dopants onto an oxide or mixed-oxide support using an incipient wetness technique to form an oxide catalyst. In some embodiments, the process comprises depositing one or more oxide dopants onto an oxide or mixed-oxide support by precipitating the dopant precursors in a liquid solution to form an oxide catalyst. In some embodiments, the process further comprises physically blending an H-zeolite with the oxide catalyst in a slurry state to form a blend. In some embodiments, the process further comprises physically blending a zeolite capable of being converted to an H-zeolite with the oxide catalyst in a slurry state to form a blend. In some embodiments, the process further includes calcining the blend at a temperature of at least about 450° C. for about 1 hour to obtain the catalyst composition.

In some embodiments, there is provided a process for reducing NOₓ formation in an exhaust gas. In some embodiments, the process comprises contacting the exhaust gas stream, in the presence of a reducing agent, such as urea solution or gaseous ammonia, with a catalyst composition of the present disclosure.

In some embodiments, the temperature of the process is less than or about 250° C. In some embodiments, temperature of the process is about 250° C. In some embodiments, temperature of the process is about 240° C. In some embodiments, temperature of the process is about 230° C. In some embodiments, temperature of the process is about 220° C. In some embodiments, temperature of the process is about 210° C. In some embodiments, temperature of the process is about 200° C.

In some embodiments, there is provided a catalytic article comprising a substrate having a plurality of channels for gas flow and the catalyst composition of the present disclosure disposed thereon.

In some embodiments, there is provided a method for treating an exhaust gas comprising NOₓ. In some embodiments, the method comprising contacting the exhaust gas with the catalytic article of the present disclosure for a time and at a temperature ranging from about 200° C. to about 250° C. or higher. In some embodiments, the temperature is about 200° C. In some embodiments, the temperature is about 210° C. In some embodiments, the temperature is about 220° C. In some embodiments, the temperature is about 230° C. In some embodiments, the temperature is about 240° C. In some embodiments, the temperature is about 250° C. In some embodiments, the temperature is greater than about 250° C.

In some embodiments, there is provided a method for treating an exhaust gas comprising NOₓ in a heavy-duty application positioned at a close-couple position using the catalytic article of the present disclosure.

In some embodiments, the level of NOₓ conversion in the exhaust gas at about 250° C. using the catalyst of the present disclosure is at least about 18% higher than the catalyst composition without the H-zeolite, or zeolite capable of being converted into an H-zeolite, blended therein. In some embodiments, the level of NOₓ conversion is at least about 18% higher. In some embodiments, the level of NOₓ conversion is at least about 20% higher. In some embodiments, the level of NOₓ conversion is at least about 25% higher. In some embodiments, the level of NOₓ conversion is at least about 30% higher. In some embodiments, the level of NOₓ conversion is at least about 34% higher.

In some embodiments, the formation of N₂O at about 250° C. is at least about 5 times lower than the catalyst composition without the H-zeolite, or zeolite capable of being converted into an H-zeolite, blended therein.

In some embodiments, there is provided an emission treatment system for treating an exhaust gas stream. In some embodiments, the emission treatment system comprises an engine producing an exhaust gas stream: and the catalytic article of the present disclosure positioned downstream from the engine in fluid communication with the exhaust gas stream.

In some embodiments, emission treatment system further comprising one or more of a diesel oxidation catalyst (DOC), a catalyzed soot filter (CSF), a soot filter, an ammonia oxidation (AMOₓ) catalyst, a lean NOₓ trap (LNT), and a nitrogenous reductant injector. In some embodiments, emission treatment system further comprises a diesel oxidation catalyst (DOC). In some embodiments, emission treatment system further comprises a catalyzed soot filter (CSF). In some embodiments, emission treatment system further comprises a soot filter. In some embodiments, emission treatment system further comprises an ammonia oxidation (AMOₓ) catalyst. In some embodiments, emission treatment system further comprises a lean NOₓ trap (LNT). In some embodiments, emission treatment system further comprises a nitrogenous reductant injector.

Claims or descriptions that include “or” or “and/or” between at least one member of a group are considered satisfied if one, more than one, or all of the group members are present in, employed in, or otherwise relevant to a given product, process, or system unless indicated to the contrary or otherwise evident from the context. The disclosure includes embodiments in which exactly one member of the group is present in, employed in, or otherwise relevant to a given product, process, or system. The disclosure includes embodiments in which more than one, or all the group members are present in, employed in, or otherwise relevant to a given product, process, or system.

Furthermore, the disclosure encompasses all variations, combinations, and permutations in which at least one limitation, element, clause, or descriptive term from at least one of the listed claims is introduced into another claim. For example, any claim that is dependent on another claim can be modified to include at least one limitation found in any other claim that is dependent on the same base claim. Where elements are presented as lists, such as, e.g., in Markush group format, each subgroup of the elements is also disclosed, and any element(s) can be removed from the group. It should be understood that, in general, where the disclosure, or aspects of the disclosure, is/are referred to as comprising particular elements and/or features, embodiments of the disclosure or aspects of the disclosure consist, or consist essentially of, such elements and/or features. For purposes of simplicity, those embodiments have not been specifically set forth in haec verba herein. Where ranges are given, endpoints are included. Furthermore, unless otherwise indicated or otherwise evident from the context and understanding of one of ordinary skill in the art, values that are expressed as ranges can assume any specific value or sub range within the stated ranges in different embodiments of the disclosure, unless the context clearly dictates otherwise.

Those of ordinary skill in the art will recognize or be able to ascertain using no more than routine experimentation, many equivalents to the specific embodiments of the disclosure described herein. Such equivalents are intended to be encompassed by the claims.

Before describing exemplary embodiments of the present disclosure, it is to be understood that the disclosure is not limited to the details of construction or process steps set forth in the following examples and is capable of other embodiments and of being practiced or being carried out in various ways.

### EXAMPLES

The following examples are intended to be illustrative and are not meant in any way to limit the scope of the disclosure.

### Powder Catalyst Preparation

### Oxide Catalysts

Oxide-based catalysts were prepared by impregnating one or more oxides (doped oxides) on an oxide or mixed oxide support.

For Nb-free oxide catalysts (Samples 1, 2, 7, and 8), metal oxides were co-impregnated onto supports by using mixed metal salt solutions. For example, Sample 1 was prepared by co-impregnating Mn/Ce nitrate solution on 5% WO₃/TiO₂ support using the incipient wetness technique. After impregnation, the sample was calcined in air at 500° C. for 2 hours.

For Nb-containing catalysts (Sample 3-6, 9, and 10), sequential impregnation was employed with Nb impregnation as the second step. For example, Sample 3 was prepared by impregnating Mn nitrate on 50% CeO₂/Al₂O₃ support first followed by a calcination in air at 500° C. for 2 hours. The resulting material was further impregnated with an ammonium niobate(V) oxalate solution. After the second impregnation, the resulting powder was calcined again in air at 500° C. for 2 hours.

### Oxide/Zeolite Mixture Catalysts

An additional zeolite component is added to the oxide component in the slurry stage (see Sample shaping). The amount of zeolite is 10%, 20%, 30%, or 50% of the oxide catalyst.

### Sample Shaping

To make powder catalysts suitable for reactor evaluation, oxide catalyst or oxide+zeolite was suspended into deionized water with about 30% solid. An alumina-based binder (about 5 wt %) was added to the slurry. The catalyst slurry was dried by stirring at 100° C. and then calcined at 550° C. for 1 hour. The resulting material was crushed and sieved to 250-500 mm fraction. The so obtained catalysts are labelled as “fresh” catalysts.

### Catalyst Identification and Compositions

Table 1 summarizes the catalyst compositions of Group I samples. This matrix is designed to investigate the effect of zeolite addition over a variety of catalyst compositions.

The oxide and mixed oxide supports were obtained commercially through various suppliers. The level of a doped oxide is expressed as wt % of the total oxide catalyst. The amount of zeolite is additional 20 wt % of the oxide catalyst. All zeolites were initially in ammonium form but converted to hydrogen form by calcining at 450° C. for 5 hours before mixing with an oxide catalyst. BEA is zeolite beta with a SiO₂/Al₂O₃ ratio of 25. FER is ferrierite with a SiO₂/Al₂O₃ ratio of 20.

TABLE 1
Summary of catalyst compositions (Group I)

| | | | | | | Additional |
|---|---|---|---|---|---|---|
| Sample | Composition of | Doped Oxides (wt. %) | | | | Zeolite |
| ID | Oxide Support | MnO₂ | CeO₂ | Nb₂O₅ | CuO | Component |
| 1 | 5% WO₃/TiO₂ | 5 | 10 | — | — | — |
| 1A | 5% WO₃/TiO₂ | 5 | 10 | — | — | 20% BEA |
| 1B | 5% WO₃/Al₂O₃ | 5 | 10 | — | — | 20% FER |
| 2 | 20% CeO₂/Al₂O₃ | 5 | — | — | — | — |
| 2A | 20% CeO₂/Al₂O₃ | 5 | — | — | — | 20% BEA |
| 2B | 20% CeO₂/Al₂O₃ | 5 | — | — | — | 20% FER |
| 3 | 50% CeO₂/Al₂O₃ | 5 | — | 5 | — | — |
| 3A | 50% CeO₂/Al₂O₃ | 5 | — | 5 | — | 20% BEA |
| 4 | CeO₂ | 5 | — | 5 | — | — |
| 4A | CeO₂ | 5 | — | 5 | — | 20% BEA |
| 5 | 50% CeO₂/Al₂O₃ | — | — | 5 | 1 | — |
| 5A | 50% CeO₂/Al₂O₃ | — | — | 5 | 1 | 20% BEA |
| 6 | CeO₂ | — | — | 5 | 1 | — |
| 6A | CeO₂ | — | — | 5 | 1 | 20% BEA |
| 7 | 5% MnO₂/Al₂O₃ | 2 | 10 | — | — | — |
| 7A | 5% MnO₂/Al₂O₃ | 2 | 10 | — | — | 20% BEA |
| 7B | 5% MnO₂/Al₂O₃ | 2 | 10 | — | — | 20% FER |
| 8 | 8% SiO₂/Al₂O₃ | 5 | 10 | — | — | — |
| 8A | 8% SiO₂/Al₂O₃ | 5 | 10 | | — | 20% BEA |
| 9 | Ce/Zr/La (86/10/4) | 5 | — | 5 | — | — |
| 9A | Ce/Zr/La (86/10/4) | 5 | — | 5 | — | 20% BEA |
| 10 | Ce/Zr/La/Y | 5 | — | 5 | — | — |
| | (20/70/5/5) | | | | | |
| 10 | Ce/Zr/La/Y | 5 | — | 5 | — | 20% BEA |
| | (20/70/5/5) | | | | | |
| 11 | 18% MnO₂/ZrO₂ | — | — | — | — | — |
| 11A | 18% MnO₂/ZrO₂ | — | — | — | — | 20% BEA |

Table 2 summarizes the catalyst composition of Group II samples, which is designed to investigate the effect of zeolite addition as a function of zeolite structures. The oxide catalyst component (Sample 2) is 5% MnO₂ supported on 20% CeO₂/Al₂O₃. The amount of zeolite is additional 20 wt % of the oxide catalyst. All zeolites are in hydrogen form. BEA is zeolite beta with a SiO₂/Al₂O₃ ratio of 25. FER is ferrierite with a SiO₂/Al₂O₃ ratio of 20. MOR is mordenite with a SiO₂/Al₂O₃ ratio of 20. MFI is ZSM-5 with a SiO₂/Al₂O₃ ratio of 30. FAU is zeolite Y with a SiO₂/Al₂O₃ ratio of 30. CHA is chabazite with a SiO₂/Al₂O₃ ratio of 24.

TABLE 2
Summary of catalyst compositions (Group II)

| Sample | | | Additional |
|---|---|---|---|
| ID | Support composition | Oxide dopant | zeolite |
| 2 | 20% CeO₂/Al₂O₃ | 5% MnO₂ | none |
| 2A | 20% CeO₂/Al₂O₃ | 5% MnO₂ | 20% BEA |
| 2B | 20% CeO₂/Al₂O₃ | 5% MnO₂ | 20% FER |
| 2C | 20% CeO₂/Al₂O₃ | 5% MnO₂ | 20% MOR |
| 2D | 20% CeO₂/Al₂O₃ | 5% MnO₂ | 20% MFI |
| 2E | 20% CeO₂/Al₂O₃ | 5% MnO₂ | 20% FAU |
| 2F | 20% CeO₂/Al₂O₃ | 5% MnO₂ | 20% CHA |

Table 3 summarizes the catalyst composition of Group III samples, which is designed to investigate the effect of zeolite addition as a function of zeolite structures with the oxide catalyst component (Sample 11) being 18% MnO₂/ZrO₂. The amount of zeolite is additional 20 wt % of the oxide catalyst. The zeolites used in this group are same as in Group II.

TABLE 3
Summary of catalyst compositions (Group III)

| Sample | | | Additional |
|---|---|---|---|
| ID | Catalyst composition | Oxide dopant | zeolite |
| 11 | 18% MnO₂/ZrO₂ | none | none |
| 11A | 18% MnO₂/ZrO₂ | none | 20% BEA |
| 11B | 18% MnO₂/ZrO₂ | none | 20% FER |
| 11C | 18% MnO₂/ZrO₂ | none | 20% MOR |
| 11D | 18% MnO₂/ZrO₂ | none | 20% MFI |
| 11E | 18% MnO₂/ZrO₂ | none | 20% FAU |
| 11F | 18% MnO₂/ZrO₂ | none | 20% CHA |

Table 4 summarizes the catalyst composition of Group IV samples, which is designed to investigate the effect of zeolite addition as a function of zeolite quantity. Two oxide compositions are used as the base catalysts: Sample 2 (5% MnO₂ supported on 20% CeO₂/Al₂O₃) and Sample 11 (18% MnO₂/ZrO₂). The zeolite is BEA (zeolite beta), and the zeolite is added to an oxide catalyst as additional 10%, 20 w %, 30%, or 50% by weight of the oxide catalyst.

TABLE 4
Summary of catalyst compositions (Group IV)

| Sample | | | Additional |
|---|---|---|---|
| ID | Catalyst composition | Oxide dopant | zeolite |
| 2 | 20% CeO₂/Al₂O₃ | 5% MnO₂ | None |
| 2A-10 | 20% CeO₂/Al₂O₃ | 5% MnO₂ | 10% BEA |
| 2A-20 | 20% CeO₂/Al₂O₃ | 5% MnO₂ | 20% BEA |
| 2A-30 | 20% CeO₂/Al₂O₃ | 5% MnO₂ | 30% BEA |
| 2A-50 | 20% CeO₂/Al₂O₃ | 5% MnO₂ | 50% BEA |
| 11 | 18% MnO₂/ZrO₂ | none | None |
| 11A-10 | 18% MnO₂/ZrO₂ | none | 10% BEA |
| 11A-20 | 18% MnO₂/ZrO₂ | none | 20% BEA |
| 11A-30 | 18% MnO₂/ZrO₂ | none | 30% BEA |
| 11A-50 | 18% MnO₂/ZrO₂ | none | 50% BEA |

### Monolith Sample Preparation

Monolith Sample 1 (Nb₂O₅/CuO/CeO₂):

CuO/CeO₂ powder was first prepared by impregnating a Cu solution on CeO₂. The Cu solution is a 0.5 M Cu(NH₃)₄(NO₃)₂ solution prepared by adding 25% NH₃·H₂O to a Cu(NO₃)₂ solution with a molar ratio NH₃/Cu of 8. The Cu solution was impregnated on the CeO₂ powder using the incipient wetness technique to reach a CuO loading of 1.09% by weight after calcination. The resulting powder was dried at 110° C. for 4 hours and then calcined at 550° C. for 2 hours with ramp rate of 5° C./min. The CuO/CeO₂ powder was further impregnated with a Nb solution (1 M C₄H₄NNbO₉) to reach a final composition of 8% Nb₂O₅ and 1% CuO on CeO₂. The Nb₂O₅/CuO/CeO₂ powder was again dried at 110° C. for 4 hours and then calcined at 550° C. for 2 hours with ramp rate of 5° C./min.

A washcoat slurry was prepared by adding Nb₂O₅/CuO/CeO₂ powder along with a Zr acetate binder (0.1 g/in³) and an alumina binder (0.2 g/in³) in deionized water with stirring. The slurry was then milled to 90% particles <16 μm (D90<16 μm). The slurry was coated on a small monolith core (13 cell×13 cell×3″ long) at pH between 3.5 and 4.5. The coated sample was dried at 110° C. for 2 hours and calcined at 450° C. for 1hour (fresh sample). The washcoat loading for the oxide is 2 g/in³.

Monolith Sample 2 (Nb₂O₅/CuO/CeO₂+20% H-CHA):

Same oxide powder was used for Monolith Sample 2. In addition, a H-form of chabazite zeolite was added to the slurry. The washcoat loading of the oxide is 1.6 g/in³ and that of zeolite is 0.4 g/in³. Therefore, the total washcoat loading for Monolith Sample 1 and Monolith Sample 2 is the same.

Monolith Sample 3 (MnO₂/TiO₂/CeO₂/Al₂O₃):

A powder sample (MnO₂/TiO₂/CeO₂/Al₂O₃) was first prepared by co-impregnating a Mn—Ti solution on a commercial CeO₂/Al₂O₃ (20% CeO₂) support. The Mn—Ti solution was prepared by first dissolving Mn(NO₃)₂·4H₂O in ethanol and then adding tetrabutyl titanate to the Mn solution. The Mn—Ti solution was impregnated on the CeO₂/Al₂O₃ support using incipient wetness technique. The resulting powder was dried at 100° C. for 1 hour and calcined at 500° C. for 2 hours. The calcined powder has a composition of 6.6 wt % MnO₂, 3.4 wt % TiO₂ and 90 wt % CeO₂/Al₂O₃.

A washcoat slurry was prepared by adding MnO₂/TiO₂/CeO₂/Al₂O₃ powder along with an alumina binder (0.1 g/in³) in deionized water with stirring. The slurry was then milled to 90% particles <12 μm (D₉₀<12 μm). The slurry was coated on a small monolith core (13 cell×13 cell×3″ long) at pH between 4.5 and 5.5. The coated sample was dried at 110° C. for 2 hours and calcined at 450° C. for 1 hour (fresh sample). The washcoat loading for the oxide is 2 g/in³.

Monolith Sample 4 (MnO₂/TiO₂/CeO₂/Al₂O₃+20% H-Beta):

Same oxide powder was used for Monolith Sample 4. In addition, an H-form of beta zeolite was added to the slurry. The washcoat loading of the oxide is 2 g/in³ and that of zeolite is 0.4 g/in³.

### Catalyst Aging

Catalysts were aged at 650° C. for 50 hours with 10% steam in air.

### Catalyst Testing Procedures

### Test Procedures for Powder Samples

Fresh and aged catalysts were tested in a high throughput reactor with a feed consisting of 500 ppm NO, 500 ppm NH₃, 5% H₂O, 10% O₂ and balance N₂. For oxide and oxide/zeolite catalysts, 120 mg and 144 mg samples were used, respectively. The sample was diluted to 1 mL volume with corundum, which corresponds to a simulated monolithic space velocity of 80,000 h⁻¹ assuming 2 g/in³ washcoat loading. The activity was evaluated at constant temperatures at 175° C., 200° C., 225° C., 250° C., 300° C., 400° C., 550° C., and 575° C.

### Test Procedures for Monolith Samples:

Monolith samples were tested in a monolith reactor with a feed consisting of 500 ppm NO, 500 ppm NH₃, 5% H₂O, 10% O₂, 5% CO₂, and balance N₂ at a monolith space velocity of 80,000 h⁻¹. The activity was evaluated at constant temperatures at 125° C., 150° C., 175° C., 200° C., 225° C., 250° C., 300° C., 400° C., and 450° C.

### Test Results

### Powder Samples:

Table 5 summarizes the test results (NOₓ conversion and N₂O formation) for fresh catalysts of Group I samples at 200° C., 250° C., 300° C., and 400° C. Adding a small amount of zeolite (beta or ferrierite) to an oxide-based catalyst substantially increases the NOₓ conversion relative to the oxide catalyst (Samples 1-11) at all temperatures. This activity enhancement was observed for all catalyst compositions (Samples 1-11). Simultaneously, zeolite addition results in lower N₂O formation on most catalysts, especially for the oxide catalysts that produce high N₂O. For example, adding beta zeolite to Sample 4 (Sample 4A) reduces N₂O formation to 4 ppm, 9 ppm, 26 ppm, and 78 ppm from 8 ppm, 22 ppm, 91 ppm, and 203 ppm at 200° C., 250° C., 300° C., and 400° C., respectively. The effect on N₂O reduction is even more pronounced for Sample 11 (98 ppm N₂O on Sample 11 vs. 5 ppm on Sample 11A at 300° C.). The performance of the zeolite materials was also tested. Both BEA and FER have NOₓ conversion near baseline levels, especially at temperatures below 300° C. Therefore, the increased NOₓ conversion and decreased N₂O formation on the zeolite- containing catalysts is due to the synergistic interaction between the oxide component and the zeolite component.

TABLE 5
SCR performance on fresh catalysts (Group I samples)

| | NOₓ Conversion (%) | | | | N₂O Formation (ppm) | | | |
|---|---|---|---|---|---|---|---|---|
| Sample | 200° C. | 250° C. | 300° C. | 400° C. | 200° C. | 250° C. | 300° C. | 400° C. |
| 1 | 8 | 27 | 58 | 88 | 3 | 3 | 3 | 9 |
| 1A | 14 | 37 | 70 | 92 | 3 | 3 | 5 | 13 |
| 1B | 13 | 37 | 69 | 92 | 3 | 3 | 4 | 12 |
| 2 | 10 | 28 | 61 | 78 | 4 | 5 | 16 | 60 |
| 2A | 29 | 58 | 89 | 94 | 3 | 2 | 5 | 26 |
| 2B | 27 | 56 | 86 | 88 | 3 | 4 | 10 | 37 |
| 3 | 20 | 38 | 63 | 73 | 4 | 5 | 13 | 63 |
| 3A | 26 | 57 | 89 | 96 | 3 | 3 | 5 | 19 |
| 4 | 50 | 72 | 71 | 14 | 8 | 22 | 91 | 203 |
| 4A | 71 | 92 | 96 | 65 | 4 | 9 | 26 | 78 |
| 5 | 8 | 23 | 48 | 87 | 3 | 3 | 2 | 1 |
| 5A | 18 | 41 | 69 | 97 | 3 | 2 | 1 | 0 |
| 6 | 26 | 52 | 73 | 74 | 3 | 2 | 3 | 9 |
| 6A | 34 | 65 | 87 | 96 | 3 | 3 | 3 | 2 |
| 7 | 18 | 42 | 71 | 50 | 4 | 10 | 34 | 69 |
| 7A | 31 | 63 | 90 | 83 | 3 | 4 | 10 | 31 |
| 7B | 24 | 53 | 82 | 80 | 3 | 4 | 11 | 36 |
| 8 | 1 | 15 | 42 | 74 | 0 | 2 | 4 | 26 |
| 8A | 3 | 24 | 60 | 95 | 1 | 1 | 2 | 7 |
| 9 | 35 | 61 | 67 | 27 | 3 | 8 | 31 | 144 |
| 9A | 44 | 76 | 93 | 73 | 3 | 5 | 13 | 53 |
| 10 | 15 | 35 | 53 | 43 | 2 | 5 | 14 | 89 |
| 10 | 25 | 57 | 87 | 88 | 2 | 4 | 8 | 20 |
| 11 | 11 | 16 | 20 | 0 | 2 | 13 | 98 | 187 |
| 11A | 33 | 73 | 96 | 84 | 1 | 1 | 5 | 33 |
| BEA | 1 | 2 | 4 | 11 | 1 | 1 | 13 | 55 |
| FER | 2 | 1 | 4 | 0 | 1 | 4 | 24 | 59 |

Table 6 summarizes the test results (NOₓ conversion and N₂O formation) for aged catalysts of Group I samples at 200° C., 250° C., 300° C., and 400° C. In general, catalyst aging decreases the benefit of zeolite addition, and the degree of decrease depends on the catalyst system. On some catalysts (Samples 3, 4 7, 8, 9, and 10), there is less or no benefit in NOₓ conversion at low temperatures but significant activity enhancement at high temperatures. On other catalysts (Samples 2 and 11), a significant activity improvement was observed for both low and high temperatures. For N₂O formation, aged catalyst stills show beneficial effect of zeolite addition in N₂O reduction. On aged Sample 11, zeolite addition shows a striking effect in enhancing NOₓ conversion and reducing N₂O formation.

TABLE 6
SCR performance on aged catalysts (Group I samples)

| | NOₓ Conversion (%) | | | | N₂O Formation (ppm) | | | |
|---|---|---|---|---|---|---|---|---|
| Sample | 200° C. | 250° C. | 300° C. | 400° C. | 200° C. | 250° C. | 300° C. | 400° C. |
| 1 | 3 | 7 | 16 | 45 | 1 | 2 | 2 | 2 |
| 1A | 3 | 4 | 16 | 44 | 1 | 2 | 2 | 1 |
| 1B | 4 | 8 | 19 | 50 | 1 | 2 | 1 | 1 |
| 2 | 9 | 24 | 58 | 80 | 1 | 2 | 7 | 45 |
| 2A | 8 | 19 | 37 | 82 | 1 | 2 | 2 | 5 |
| 2B | 13 | 30 | 57 | 90 | 1 | 2 | 4 | 23 |
| 3 | 13 | 25 | 50 | 75 | 1 | 2 | 5 | 64 |
| 3A | 8 | 23 | 48 | 86 | 1 | 2 | 2 | 21 |
| 4 | 60 | 82 | 86 | 43 | 12 | 28 | 79 | 190 |
| 4A | 53 | 80 | 89 | 61 | 10 | 22 | 48 | 109 |
| 5 | 7 | 18 | 39 | 83 | 1 | 2 | 1 | 1 |
| 5A | 8 | 19 | 38 | 78 | 1 | 2 | 2 | 1 |
| 6 | 14 | 35 | 60 | 72 | 2 | 6 | 13 | 33 |
| 6A | 14 | 37 | 65 | 87 | 2 | 4 | 7 | 22 |
| 7 | 13 | 32 | 66 | 66 | 2 | 4 | 13 | 58 |
| 7A | 11 | 25 | 47 | 79 | 1 | 2 | 4 | 25 |
| 7B | 13 | 28 | 52 | 79 | 2 | 2 | 6 | 36 |
| 8 | 2 | 7 | 18 | 42 | 5 | 5 | 8 | 30 |
| 8A | 2 | 10 | 25 | 62 | 4 | 4 | 4 | 7 |
| 9 | 27 | 50 | 64 | 41 | 4 | 7 | 25 | 128 |
| 9A | 19 | 43 | 68 | 75 | 4 | 5 | 13 | 53 |
| 10 | 17 | 32 | 47 | 39 | 3 | 3 | 8 | 70 |
| 10 | 15 | 32 | 55 | 76 | 4 | 2 | 6 | 25 |
| 11 | 31 | 43 | 43 | 0 | 13 | 51 | 174 | 184 |
| 11A | 29 | 64 | 91 | 69 | 4 | 6 | 18 | 61 |
| BEA | 1 | 1 | 4 | 8 | 1 | 2 | 13 | 51 |
| FER | 0 | 2 | 2 | 0 | 1 | 1 | 6 | 21 |

Table 7 summarizes the fresh results of Group II samples. Addition of 20% zeolite of any structure (BEA, FER, MOR, MFI, FAU, or CHA) significantly increases the NOₓ conversion relative to the base catalyst (Sample 2: 5% MnO₂ on 20% CeO₂/Al₂O₃) at any temperature. The activity enhancement is especially pronounced at low temperatures (200° C. and 250° C.). In general, the zeolite-containing catalysts generate no N₂O at 200° C. and 250° C. and lower N₂O at 300° C. and 400° C. compared to the base catalyst.

TABLE 7
SCR performance on fresh catalysts (Group II samples)

| | NOₓ Conversion (%) | | | | N₂O Formation (ppm) | | | |
|---|---|---|---|---|---|---|---|---|
| Sample | 200° C. | 250° C. | 300° C. | 400° C. | 200° C. | 250° C. | 300° C. | 400° C. |
| 2 | 8 | 25 | 55 | 72 | 1 | 2 | 16 | 67 |
| 2A | 24 | 54 | 91 | 83 | 0 | 0 | 1 | 35 |
| BEA | 1 | 2 | 4 | 11 | 1 | 1 | 13 | 55 |
| 2B | 23 | 51 | 83 | 80 | 0 | 0 | 6 | 48 |
| FER | 2 | 1 | 4 | 0 | 1 | 4 | 24 | 59 |
| 2C | 18 | 51 | 83 | 81 | 0 | 0 | 7 | 59 |
| MOR | 2 | 2 | 2 | 0 | 1 | 1 | 3 | 5 |
| 2D | 26 | 55 | 90 | 81 | 0 | 0 | 6 | 60 |
| MFI | 1 | 0 | 2 | 0 | 1 | 2 | 9 | 23 |
| 2E | 17 | 42 | 78 | 83 | 6 | 0 | 0 | 25 |
| FAU | 2 | 0 | 1 | 0 | 1 | 1 | 5 | 7 |
| 2F | 25 | 62 | 84 | 75 | 0 | 0 | 3 | 39 |
| CHA | 2 | 2 | 4 | 0 | 1 | 3 | 23 | 28 |

Table 8 summarizes the aged results of Group II samples. After aging, in general the benefit of zeolite inclusion decreases. The most active catalyst is Sample 2F (Sample 2+20% CHA), its conversion is about twice that of the base catalyst at 200° C. and 250° C. N₂O formation on the aged catalysts is still lower than that over the base catalyst at lower temperatures.

TABLE 8
SCR performance on aged catalysts (Group II samples)

| | NOₓ Conversion (%) | | | | N₂O Formation (ppm) | | | |
|---|---|---|---|---|---|---|---|---|
| Sample | 200° C. | 250° C. | 300° C. | 400° C. | 200° C. | 250° C. | 300° C. | 400° C. |
| 2 | 10 | 25 | 60 | 75 | 4 | 4 | 11 | 42 |
| 2A | 12 | 28 | 57 | 85 | 3 | 2 | 5 | 18 |
| BEA | 1 | 1 | 4 | 8 | 1 | 2 | 13 | 51 |
| 2B | 16 | 37 | 66 | 83 | 3 | 2 | 4 | 28 |
| FER | 0 | 2 | 2 | 0 | 1 | 1 | 6 | 21 |
| 2C | 13 | 29 | 59 | 75 | 3 | 3 | 12 | 44 |
| MOR | 2 | 1 | 3 | 4 | 1 | 2 | 13 | 37 |
| 2D | 14 | 30 | 62 | 86 | 3 | 3 | 7 | 31 |
| MFI | 0 | 1 | 2 | 0 | 1 | 1 | 6 | 11 |
| 2E | 13 | 26 | 55 | 86 | 3 | 2 | 3 | 15 |
| FAU | 1 | 1 | 2 | 5 | 1 | 2 | 13 | 44 |
| 2F | 20 | 45 | 74 | 81 | 2 | 1 | 4 | 28 |
| CHA | 1 | 1 | 5 | 0 | 1 | 2 | 13 | 30 |

Table 9 summarizes the fresh results of Group III samples. The NOₓ conversions over the zeolite-containing catalysts are two to four times of that of the base catalyst (Sample 11:18% MnO₂/ZrO₂) at all temperatures. The N₂O formation on the zeolite-containing catalysts are also much lower, especially at 300° C. and 400° C. relative to the base catalyst.

TABLE 9
SCR performance on fresh catalysts (Group III samples)

| | NOₓ Conversion (%) | | | | N₂O Formation (ppm) | | | |
|---|---|---|---|---|---|---|---|---|
| Sample | 200° C. | 250° C. | 300° C. | 400° C. | 200° C. | 250° C. | 300° C. | 400° C. |
| 11 | 15 | 25 | 32 | 21 | 0 | 9 | 72 | 198 |
| 11A | 55 | 90 | 92 | 80 | 0 | 0 | 7 | 58 |
| 11B | 40 | 81 | 90 | 75 | 0 | 0 | 3 | 42 |
| 11C | 36 | 83 | 91 | 84 | 0 | 0 | 0 | 17 |
| 11D | 48 | 89 | 94 | 83 | 0 | 0 | 0 | 17 |
| 11E | 35 | 83 | 80 | 54 | 0 | 0 | 2 | 36 |
| 11F | 31 | 66 | 80 | 55 | 0 | 0 | 25 | 116 |

Table 10 summarizes the aged results of Group III samples. The effect of zeolite is largely maintained after aging. The NOₓ conversion at 250° C. is 18% to 34% higher on the zeolite-containing catalysts (58% to 74%) than the base catalyst (40%). Sample 11F (Sample 11+20% CHA) is the most active aged catalyst in this group. All zeolite containing catalysts generate much lower N₂O at all temperatures.

TABLE 10
SCR performance on aged catalysts (Group III samples)

| | NOₓ Conversion (%) | | | | N₂O Formation (ppm) | | | |
|---|---|---|---|---|---|---|---|---|
| Sample | 200° C. | 250° C. | 300° C. | 400° C. | 200° C. | 250° C. | 300° C. | 400° C. |
| 11 | 28 | 40 | 44 | 7 | 10 | 37 | 137 | 190 |
| 11A | 26 | 62 | 92 | 76 | 3 | 5 | 16 | 56 |
| 11B | 35 | 70 | 89 | 56 | 4 | 7 | 28 | 84 |
| 11C | 27 | 58 | 83 | 61 | 5 | 10 | 32 | 78 |
| 11D | 27 | 70 | 92 | 72 | 4 | 3 | 12 | 43 |
| 11E | 23 | 63 | 92 | 79 | 3 | 3 | 10 | 37 |
| 11F | 41 | 74 | 85 | 44 | 4 | 10 | 46 | 114 |

Table 11 shows the effect of zeolite (BEA) quantity on the fresh performance based on Sample 2 and Sample 11. For Sample 2, adding 10% zeolite dramatically increases the NOₓ conversion. However, varying the zeolite quantity between 10% and 50% does not seem to have a significant difference for the effect. For Sample 11, adding 10% zeolite more than triples the NO conversion at 200° C. and 250° C. The NOₓ conversion further increases with increasing zeolite quantity at 200° C. but reaches a plateau at higher temperatures. No N₂O was detected on all the zeolite-containing catalysts at 200° C. and 250° C. much lower N₂O at 300° C. and 400° C.

TABLE 11
SCR performance on fresh catalysts (Group IV samples)

| | NOₓ Conversion (%) | | | | N₂O Formation (ppm) | | | |
|---|---|---|---|---|---|---|---|---|
| Sample | 200° C. | 250° C. | 300° C. | 400° C. | 200° C. | 250° C. | 300° C. | 400° C. |
| 2 | 8 | 25 | 55 | 72 | 1 | 2 | 16 | 67 |
| 2A-10 | 23 | 50 | 90 | 83 | 0 | 0 | 1 | 39 |
| 2A-20 | 24 | 54 | 91 | 83 | 0 | 0 | 1 | 35 |
| 2A-30 | 28 | 58 | 91 | 86 | 0 | 0 | 1 | 35 |
| 2A-50 | 20 | 58 | 89 | 85 | 0 | 0 | 3 | 40 |
| 11 | 15 | 25 | 32 | 21 | 0 | 9 | 72 | 198 |
| 11A-10 | 48 | 89 | 92 | 80 | 0 | 0 | 4 | 46 |
| 11A-20 | 55 | 90 | 92 | 80 | 0 | 0 | 7 | 58 |
| 11A-30 | 58 | 92 | 93 | 83 | 0 | 0 | 5 | 56 |
| 11A-50 | 64 | 92 | 94 | 85 | 0 | 0 | 1 | 28 |

Table 12 shows the effect of zeolite (BEA) quantity on the aged performance based on Sample 2 and Sample 11. For Sample 2, addition of zeolite between 10% and 30% is almost indistinguishable in terms of the zeolite effect. Adding 50% zeolite seems to have a slight disadvantage at 200° C. For Sample 11, unlike fresh catalyst, adding 10% zeolite results in the highest NOₓ conversion compared to (20%, 30%, and 50%) at 250° C. All zeolite-containing samples produce less N₂O relative to its base catalyst (Sample 2 or Sample 11).

TABLE 12
SCR performance on aged catalysts (Group IV samples)

| | NOₓ Conversion (%) | | | | N₂O Formation (ppm) | | | |
|---|---|---|---|---|---|---|---|---|
| Sample | 200° C. | 250° C. | 300° C. | 400° C. | 200° C. | 250° C. | 300° C. | 400° C. |
| 2 | 10 | 25 | 60 | 75 | 4 | 4 | 11 | 42 |
| 2A-10 | 11 | 25 | 57 | 82 | 3 | 2 | 4 | 23 |
| 2A-20 | 12 | 28 | 57 | 85 | 3 | 2 | 5 | 18 |
| 2A-30 | 12 | 25 | 51 | 86 | 3 | 2 | 6 | 20 |
| 2A-50 | 8 | 23 | 48 | 86 | 3 | 3 | 8 | 22 |
| 11 | 28 | 40 | 44 | 7 | 10 | 37 | 137 | 190 |
| 11A-10 | 27 | 64 | 91 | 67 | 4 | 7 | 21 | 69 |
| 11A-20 | 26 | 62 | 92 | 76 | 3 | 5 | 16 | 56 |
| 11A-30 | 21 | 53 | 87 | 82 | 3 | 3 | 10 | 44 |
| 11A-50 | 24 | 59 | 92 | 85 | 2 | 2 | 6 | 30 |

### Monolith Samples:

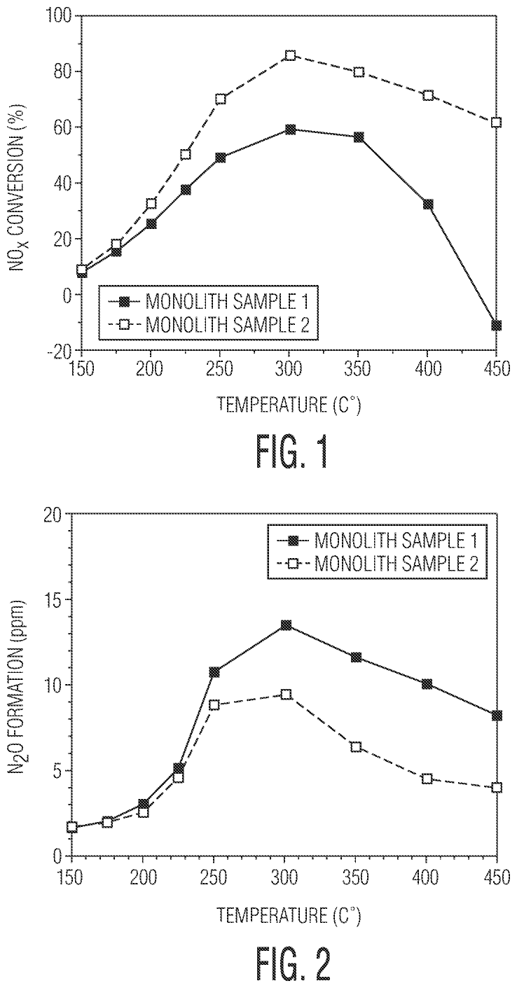

FIGS. 1 to 2 show the effect of blending H-zeolite (H-CHA) on the SCR performance of Nb/Cu based (8Nb/1Cu/CeO₂) coated monolith catalysts. The catalysts were tested as fresh in a lab reactor with a feed containing 500 ppm NO, 500 ppm NH₃, 5% H₂O, 5% CO₂, 10% O₂, and balance N₂ at GHSV=80,000 h⁻¹.

Monolith Samples 2 (H-CHA containing sample) shows much higher NOₓ conversion and lower N₂O formation relative to Monolith Sample 1 (FIG. 1). This beneficial effect is especially more pronounced at higher reaction temperatures. There is also a distinct reduction in N₂O formation (FIG. 2).

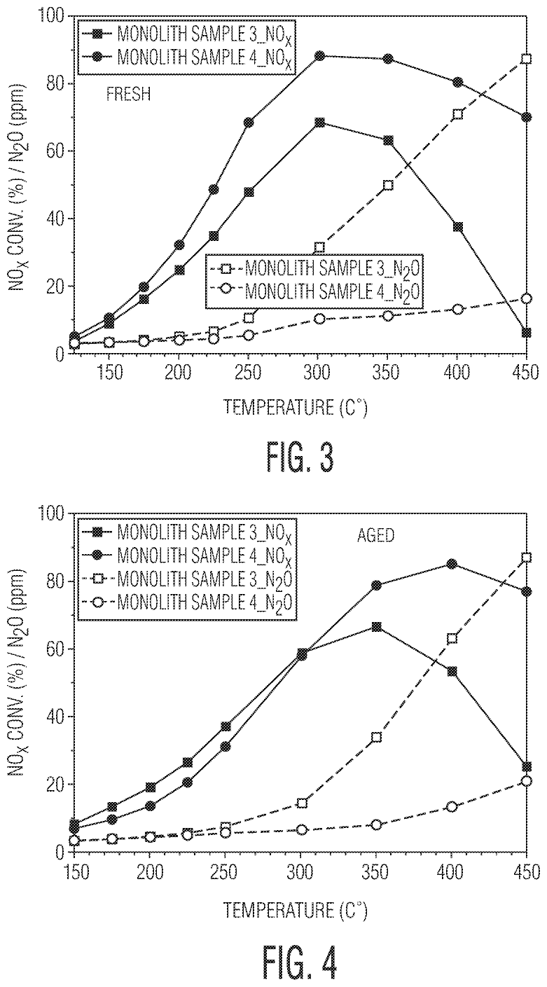

FIGS. 3 to 4 shows the SCR performance of fresh and aged Monolith Sample 3 and Monolith Sample 4. Monolith Sample 4 (H-beta containing sample) is more active in NOₓ conversion compared to Monolith Sample 3 throughout the temperature range tested (FIG. 3, solid lines). The N₂O formation on Monolith Sample 4 is low (less than 20 ppm at 450° C.), while that over Monolith Sample 3 is about 90 ppm (FIG. 3, dotted lines). These two aged catalysts show comparable NOₓ conversions at temperatures below 300° C., but above 300° C. aged Monolith Sample 4 has much higher SCR activity (FIG. 4, solid lines). The aged Monolith Sample 4 continues to show significant benefit in reducing N₂O formation (FIG. 4, dotted lines).

### Embodiments

1. A catalyst composition, for treating an exhaust gas comprising NOₓ using ammonia or urea, the catalyst composition comprising:
an oxide or mixed-oxide support impregnated with a metal oxide dopant to form an oxide catalyst, and with an H-zeolite.

2. A catalyst composition, for treating an exhaust gas comprising NOₓ using ammonia or urea, the catalyst composition comprising:
an oxide or mixed-oxide support impregnated with a metal oxide dopant to form an oxide catalyst, and with zeolite capable of being converted to an H-zeolite.

3. The catalyst composition according to embodiment 1, wherein the H-zeolite and the oxide catalyst are blended.

4. The catalyst composition according to embodiment 2, wherein the zeolite capable of being converted to an H-zeolite and the oxide catalyst are blended.

5. The catalyst composition according to any one of embodiments 1-4, wherein the oxide or mixed-oxide support is chosen from MnO₂/ZrO₂, WO₃/TiO₂, WO₃/Al₂O₃, SiO₂/Al₂O₃, Ce/Zr/La, Ce/Zr/La/Y, CeO₂, CeO₂/Al₂O₃, and combinations thereof.

6. The catalyst composition according to any one of embodiments 1-4, wherein the oxide or mixed-oxide support is MnO₂/ZrO₂.

7. The catalyst composition according to any one of embodiments 1-4, wherein the oxide or mixed-oxide support is WO₃/TiO₂.

8. The catalyst composition according to any one of embodiments 1-4, wherein the oxide or mixed-oxide support is WO₃/Al₂O₃.

9. The catalyst composition according to any one of embodiments 1-4, wherein the oxide or mixed-oxide support is SiO₂/Al₂O₃.

10. The catalyst composition according to any one of embodiments 1-4, wherein the oxide or mixed-oxide support is Ce/Zr/La.

11. The catalyst composition according to any one of embodiments 1-4, wherein the oxide or mixed-oxide support is Ce/Zr/La/Y.

12. The catalyst composition according to any one of embodiments 1-4, wherein the oxide or mixed-oxide support is CeO₂.

13. The catalyst composition according to any one of embodiments 1-4, wherein the oxide or mixed-oxide support is CeO₂/Al₂O₃.

14. The catalyst composition according to any one of embodiments 1-13, wherein the metal oxide dopant is chosen from MnO₂, CeO₂, Nb₂O₅, CuO, and combinations thereof.

15. The catalyst composition according to any one of embodiments 1-13, wherein the metal oxide dopant is MnO₂.

16. The catalyst composition according to any one of embodiments 1-13, wherein the metal oxide dopant is CeO₂.

17. The catalyst composition according to any one of embodiments 1-13, wherein the metal oxide dopant is Nb₂O₅.

18. The catalyst composition according to any one of embodiments 1-13, wherein the metal oxide dopant is CuO.

19. The catalyst composition according to any one of embodiments 1-18, wherein the H-zeolite is chosen from structures comprising BEA, FER, MOR, MFI, FAU, CHA, and combinations thereof.

20. The catalyst composition according to any one of embodiments 1-18, wherein the H-zeolite structure comprises BEA.

21. The catalyst composition according to any one of embodiments 1-18, wherein the H-zeolite structure comprises FER.

22. The catalyst composition according to any one of embodiments 1-18, wherein the H-zeolite structure comprises MOR.

23. The catalyst composition according to any one of embodiments 1-18, wherein the H-zeolite structure comprises MFI.

24. The catalyst composition according to any one of embodiments 1-18, wherein the H-zeolite structure comprises FAU.

25. The catalyst composition according to any one of embodiments 1-18, wherein the H-zeolite structure comprises CHA.

26. The catalyst composition according to any one of embodiments 1-25, wherein the H-zeolite comprises from about 5 wt % to about 50 wt % of the oxide catalyst.

27. The catalyst composition according to any one of embodiments 1-25, wherein the H-zeolite comprises from about 10 wt % to about 40 wt % of the oxide catalyst.

28. The catalyst composition according to any one of embodiments 1-25, wherein the H-zeolite comprises from about 20 wt % to about 30 wt % of the oxide catalyst.

29. The catalyst composition according to any one of embodiments 1-25, wherein the H-zeolite comprises from about 20 wt % of the oxide catalyst.

30. The catalyst composition according to any one of embodiments 1-29, wherein the metal dopant comprises from about 1 wt % to about 20 wt % of the oxide catalyst.

31. The catalyst composition according to any one of embodiments 1-29, wherein the metal dopant comprises from about 2 wt % to about 10 wt % of the oxide catalyst.

32. The catalyst composition according to any one of embodiments 1-29, wherein the metal dopant comprises from about 5 wt % of the oxide catalyst.

33. The catalyst composition according to any one of embodiments 1-32, wherein the oxide or mixed-oxide support is about 20% CeO₂/Al₂O₃.

34. The catalyst composition according to any one of embodiments 1-32, wherein the metal oxide dopant is about 5% wt % MnO₂.

35. The catalyst composition according to any one of embodiments 1-32, wherein the H-zeolite structure is about 20 wt % BEA.

36. The catalyst composition according to any one of embodiments 1-35, wherein the oxide or mixed-oxide support is about 18% MnO₂/ZrO₂.

37. The catalyst composition according to any one of embodiments 1-35, wherein the H-zeolite structure is about 20 wt % BEA.

38. The catalyst composition according to any one of embodiments 1-36, wherein the composition is a powder.

39. The catalyst composition according to any one of embodiments 1-36, wherein the composition is a coated monolith.

40. A process of making a catalyst composition, the process comprising:
(a) impregnating one or more oxide dopants onto an oxide or mixed-oxide support using an incipient wetness technique to form an oxide catalyst:
(b) physically blending an H-zeolite, or a zeolite capable of being converted into an H-zeolite, with the oxide catalyst in a slurry state; and
(c) calcining the blend at a temperature of at least about 450° C. for about 1 hour to obtain the catalyst composition.

41. A process for reducing NOₓ formation in an exhaust gas, comprising contacting the exhaust gas stream, in the presence of a reducing agent, with a catalyst composition according to any one of embodiments 1-39.

42. The process according to embodiment 41, wherein the temperature of the process is less than or about 250° C.

43. The process according to embodiment 42, wherein the temperature of the process is about 200° C.

44. A catalytic article comprising a substrate having a plurality of channels for gas flow and the catalyst composition of embodiment 1 or embodiment 2 disposed thereon.

45. A method for treating an exhaust gas comprising NOₓ, the method comprising contacting the exhaust gas with the catalytic article of embodiment 44 for a time and at a temperature ranging from about 200° C. to about 250° C. or higher.

46. The method according to embodiment 45, for use in a heavy-duty application positioned at a close-couple position.

47. The method of embodiment 46, wherein the level of NOₓ conversion in the exhaust gas at about 250° C. is at least about 18% higher than the catalyst composition without the H-zeolite, or zeolite capable of being converted to an H-zeolite, blended therein.

48. The method of embodiment 46, wherein the formation of N₂O at about 250° C. is at least about 5 times lower than the catalyst composition without the H-zeolite, or zeolite capable of being converted to an H-zeolite, blended therein.

49. An emission treatment system for treating an exhaust gas stream, the emission treatment system comprising:
an engine producing an exhaust gas stream: and
the catalytic article of embodiment 44 positioned downstream from the engine in fluid communication with the exhaust gas stream.

50. The emission treatment system of embodiment 49, further comprising one or more of a diesel oxidation catalyst (DOC), a catalyzed soot filter (CSF), a soot filter, an ammonia oxidation (AMOₓ) catalyst, a lean NOₓ trap (LNT), and a nitrogenous reductant injector.

51. The emission treatment system of embodiment 49, further comprising a diesel oxidation catalyst (DOC).

52. The emission treatment system of embodiment 49, further comprising a catalyzed soot filter (CSF).

53. The emission treatment system of embodiment 49, further comprising a soot filter.

54. The emission treatment system of embodiment 49, further comprising an ammonia oxidation (AMOₓ) catalyst.

55. The emission treatment system of embodiment 49, further comprising a lean NOₓ trap (LNT).

56. The emission treatment system of embodiment 49, further comprising a nitrogenous reductant injector.

1. A catalyst composition, for treating an exhaust gas comprising NOₓ using ammonia or urea, the catalyst composition comprising: an oxide or mixed-oxide support impregnated with a metal oxide dopant to form an oxide catalyst, and with an H-zeolite, or a zeolite capable of being converted to an H-zeolite.

2. The catalyst composition according to claim 1, wherein the H-zeolite, or the zeolite capable of being converted to an H-zeolite, and the oxide catalyst are blended.

3. The catalyst composition according to claim 1, wherein the oxide or mixed-oxide support is chosen from MnO₂/ZrO₂, WO₃/TiO₂, WO₃/Al₂O₃, SiO₂/Al₂O₃, Ce/Zr/La, Ce/Zr/La/Y, CeO₂, Ce₂/Al₂O₃, and combinations thereof.

4. The catalyst composition according to claim 1, wherein the metal oxide dopant is chosen from MnO₂, CeO₂, Nb₂O₅, CuO, and combinations thereof.

5. The catalyst composition according to claim 1, wherein the H-zeolite, or the zeolite capable of being converted to an H-zeolite, is chosen from structures comprising BEA, FER, MOR, MFI, FAU, CHA, and combinations thereof, and/or wherein the H-zeolite, or the zeolite capable of being converted into an H-zeolite, comprises from about 5 wt % to about 50 wt % of the oxide catalyst.

6. The catalyst composition according to claim 1, wherein the metal dopant comprises from about 1 wt % to about 20 wt % of the oxide catalyst.

7. The catalyst composition according to claim 1, wherein the oxide or mixed-oxide support is about 20% CeO₂/Al₂O₃; the metal oxide dopant is about 5% wt % MnO₂, and the H-zeolite structure, or zeolite structure capable of being converted into an H-zeolite structure, is about 20 wt % BEA; or wherein the oxide or mixed-oxide support is about 18% MnO₂/ZrO₂; and the H-zeolite structure, or zeolite structure capable of being converted into an H-zeolite structure, is about 20 wt % BEA.

8. The catalyst composition according to claim 1, wherein the composition is a powder or a coated monolith.

9. A process of making a catalyst composition, the process comprising:
(a) impregnating one or more oxide dopants onto an oxide or mixed-oxide support using an incipient wetness technique to form an oxide catalyst;
(b) physically blending an H-zeolite, or zeolite capable of being converted into an H-zeolite, with the oxide catalyst in a slurry state to form a blend; and
(c) calcining the blend at a temperature of at least about 450° C. for about 1 hour to obtain the catalyst composition.

10. A process for reducing NOₓ formation in an exhaust gas, comprising contacting the exhaust gas stream, in the presence of a reducing agent, with a catalyst composition according to any one of claims 1-8.

11. The process according to claim 10, wherein the temperature of the process is less than or about 250° C., preferably about 200° C.

12. A catalytic article comprising a substrate having a plurality of channels for gas flow and the catalyst composition of claim 1 disposed thereon.

13. A method for treating an exhaust gas comprising NOₓ, the method comprising contacting the exhaust gas with the catalytic article of claim 15 for a time and at a temperature ranging from about 200° C. to about 250° C. or higher, optionally for use in a heavy duty application positioned at a close-couple position.

14. The method of claim 13, wherein the level of NOₓ conversion in the exhaust gas at about 250° C. is at least about 18% higher than the catalyst composition without the H-zeolite, or zeolite capable of being converted into an H-zeolite, blended therein; or wherein the formation of N₂O at about 250° C. is at least about 5 times lower than the catalyst composition without the H-zeolite, or zeolite capable of being converted into an H-zeolite, blended therein.

15. An emission treatment system for treating an exhaust gas stream, the emission treatment system comprising:
an engine producing an exhaust gas stream; and,
the catalytic article of claim 12 positioned downstream from the engine in fluid communication with the exhaust gas stream, optionally further comprising one or more of a diesel oxidation catalyst (DOC), a catalyzed soot filter (CSF), a soot filter, an ammonia oxidation (AMOₓ) catalyst, a lean NOₓ trap (LNT), and a nitrogenous reductant injector.
